(19) United States
(12) Patent Application Publication
(10) Pub. No.: US 2013/0303410 A1
(43) Pub. Date: Nov. 14, 2013

(54) Invert Emulsion Drilling Fluids for Flat Rheology Drilling

(71) Applicant: Halliburton Energy Services, Inc., Houston, TX (US)

(72) Inventors: Vikrant Bhavanishankar Wagle, Mumbai (IN); Shadaab Syed Maghrabi, Thane (IN); Dhanashree Gajanan Kulkarni, Pune (IN)

(21) Appl. No.: 13/939,176

(22) Filed: Jul. 10, 2013

Related U.S. Application Data
(63) Continuation-in-part of application No. 13/468,022, filed on May 9, 2012.

(51) Int. Cl. C09K 8/36

(52) U.S. Cl. CPC C09K 8/36
USPC 507/128; 507/129

(57) ABSTRACT

An invert emulsion drilling fluid, and a method of drilling with such fluid, having substantially flat or relatively controlled rheology, as demonstrated by the drilling fluid exhibiting little change in its yield point and gel strength across a temperature range of from about 40° F. to about 180° F., and effected with addition of a fatty dimer diamine additive together with an acid and without the addition of organophilic clays or lignites.

### RELATED APPLICATION

This application is a continuation in part of U.S. Ser. No. 13/468,022, filed May 9, 2012, pending.

### BACKGROUND

1. Field of the Disclosure

The present disclosure relates to compositions and methods for drilling, cementing and casing boreholes in subterranean formations, particularly hydrocarbon bearing formations. More particularly, the present disclosure relates to compositions for invert emulsion drilling fluids that have flat rheology over broad temperature ranges, such as encountered in deep water, when used in drilling boreholes. The disclosure also relates to methods of drilling boreholes using such flat rheology invert emulsion drilling fluids for the recovery of hydrocarbons.

2. Description of Relevant Art

A drilling fluid or mud is a specially designed fluid that is circulated through a wellbore as the wellbore is being drilled to facilitate the drilling operation. The various functions of a drilling fluid include removing drill cuttings from the wellbore, cooling and lubricating the drill bit, aiding in support of the drill pipe and drill bit, and providing a hydrostatic head to maintain the integrity of the wellbore walls and prevent well blowouts.

An important property of the drilling fluid is its rheology, and specific rheological parameters are intended for drilling and circulating the fluid through the well bore. The fluid should be sufficiently viscous to suspend barite and drilled cuttings and to carry the cuttings to the well surface. However, the fluid should not be so viscous as to interfere with the drilling operation.

Specific drilling fluid systems are selected to optimize a drilling operation in accordance with the characteristics of a particular geological formation. Oil based muds are normally used to drill swelling or sloughing shales, salt, gypsum, anhydrite and other evaporate formations, hydrogen sulfide-containing formations, and hot (greater than about 300 degrees Fahrenheit (“° F.”) holes, but may be used in other holes penetrating a subterranean formation as well.

An oil-based or invert emulsion-based drilling fluid may commonly comprise between about 50:50 to about 95:5 by volume oil phase to water phase. Such oil-based muds used in drilling typically comprise: a base oil comprising the external phase of an invert emulsion; a saline, aqueous solution (typically a solution comprising about 30% calcium chloride) comprising the internal phase of the invert emulsion; emulsifiers at the interface of the internal and external phases; and other agents or additives for suspension, weight or density, oil-wetting, fluid loss or filtration control, and rheology control. In the past, such additives commonly included organophilic clays and organophilic lignites. However, recent technology as described for example in U.S. Pat. Nos. 7,462,580 and 7,488,704 to Kirsner, et al., introduced “clay-free” invert emulsion-based drilling fluids, which offer significant advantages over drilling fluids containing organophilic clays.

As used herein, the term “clay-free” (or “clayless”) means a drilling fluid formulated without addition of any organophilic clays or organophilic lignites to the drilling fluid composition. During drilling, such “clay-free” drilling fluids may acquire clays and/or lignites from the formation or from mixing with recycled fluids containing clays and/or lignites. However, such contamination of “clay-free” drilling fluids is preferably avoided and organophilic clays and organophilic lignites should not be deliberately added to “clay-free” drilling fluids during drilling.

Invert emulsion-based muds or drilling fluids (also called invert drilling muds or invert muds or fluids) comprise a key segment of the drilling fluids industry, and “clay-free” invert emulsion-based muds are becoming increasingly popular.

A limiting factor in drilling a particular portion of a well is the mud weight (density of the drilling fluid) that can be used. If too high a mud weight is used, fractures are created in lost-circulation zones with resulting loss of drilling fluid and other operating problems. If too low a mud weight is used, formation fluids can encroach into the well, borehole collapse may occur due to insufficient hydrostatic support, and in extreme cases safety can be compromised due to the possibility of a well blowout. Many times, wells are drilled through weak or lost-circulation-prone zones prior to reaching a potential producing zone, requiring use of a low mud weight and installation of sequential casing strings to protect weaker zones above the potential producing zone. A particularly critical drilling scenario is one that combines deepwater and shallow overburden, as is typical of ultra deepwater fields in Brazil. This scenario is characterized by high pore fluid pressure, low effective stresses, low fracturing gradients and narrow mud weight windows.

Commercially available clay-free invert emulsion drilling fluids may have less than preferred rheology at low mud weights, that is, mud weights ranging from about 9 ppg to about 12 ppg, with temperatures up to about 375° F. or higher. Commercially available invert emulsion drilling fluids are typically formulated with a type of mineral oil which is known to have relatively low viscosity that becomes even lower at such higher temperatures as typically encountered in deep wells. Such lower viscosity fluids also often have decreased rheology at such temperatures. However, during drilling offshore, conventional invert emulsion drilling fluids tend to have higher viscosity passing through the drill string and risers in deep water, with temperatures averaging about 40° F. Addition of inert solids may improve the rheology, but result in a decreased rate of penetration during drilling and loss of or decline in other benefits seen with a clay free system. Such inert solids include, for example, fine sized calcium carbonate, and the term as used herein is not meant to be understood to include or refer to drill cuttings.

Conventionally, low rheology invert emulsion drilling fluids are used for deepwater drilling at cold temperatures (typically about 40° F.). Thinners are typically added to an invert emulsion drilling fluid for use in deepwater cold temperatures (typically about 40° F.), to prevent a substantial increase in the rheology of the fluid. Low rheology, however, affects the drilling fluid's ability to clean the borehole and the fluid's ability to suspend barite and drill cuttings. An ideal deepwater invert emulsion drilling fluid exhibits sufficiently high and similar rheology from the rig floor to the riser and along the depth (or length) of the well. Such an invert emulsion drilling fluid is typically called a “flat rheology drilling fluid” or a “flat rheology fluid.”

An invert emulsion drilling fluid having and maintaining a similar rheology along the depth of a borehole leads to a controlled equivalent circulating density (ECD) along that depth. Maintaining a similar rheology leads to less fluctuation in ECD due to changes in temperature and pressure along the depth. A controlled ECD is particularly important when the fluid enters a riser or is in the vicinity of a riser at cold temperatures, that is at temperatures of about 40° F. An invert emulsion drilling fluid with a similar yield point (YP) and low-shear yield point (LSYP), would ensure the lowest possible frictional losses in the annulus and minimum hydraulic contribution to ECD. Reducing the hydraulic contribution to ECD, reduces the risk of exceeding the fracture gradient of the subterranean formation. Less fluctuation in ECDs also leads to fewer instances of lost circulation. Continuously recirculating cold, high rheology drilling fluid reduces the temperature of the drilling fluid in the pits. Colder drilling fluid leads to more resistance to flow which in turns increases the fluid column hydraulic pressure when the drilling fluid is circulating, which in turn may lead to exceeding the fracture gradient of the subterranean formation. Also colder high rheology drilling fluid necessitates the use of lower mesh screens to prevent mud losses at the shaker.

Increasingly invert emulsion-based drilling fluids are being subjected to ever greater performance and cost demands as well as environmental restrictions. Consequently, there is a continuing need and industry-wide interest in new drilling fluids that provide improved performance while still affording environmental and economical acceptance, particularly for deepwater drilling applications.

### BRIEF DESCRIPTION OF THE DRAWING

FIG. 1 is a diagram of a typical drilling fluid system in which the fluids of the disclosure may be used.

### DETAILED DESCRIPTION OF SOME EMBODIMENTS

The present disclosure provides in one embodiment oil-based, invert emulsion drilling fluids with substantially flat or relatively controlled and/or improved rheology at temperatures frequently encountered in deep water drilling, that is, temperatures ranging from about 40° F. (cold) to about 180° F. or higher. These drilling fluids provide a substantially flat or relatively controlled rheology that does not increase to levels that may fracture a subterranean formation when reduced temperatures and increased pressures are encountered, such as may occur in deepwater (at least about 1000 ft depth). The drilling fluids also exhibit similar yield points, low shear yield points, and gel strengths at temperatures ranging, or over a range of, from about 40° F. to about 180° F. or higher, indicative of flat rheology.

The present disclosure also provides in another embodiment an improved method of drilling wellbores in subterranean formations, particularly in deep water. The method employs oil-based invert emulsion muds or drilling fluids disclosed herein, having a relatively flat rheological profile over a broad temperature range. As used herein, the term “drilling” or “drilling wellbores” shall be understood in the broader sense of drilling operations, which include running casing and cementing as well as drilling, unless specifically indicated otherwise.

The invert emulsion drilling fluid of one embodiment, or used in the method of another embodiment, comprises an oil:water ratio preferably in the range of 50:50 to 95:5 and preferably employs a natural oil, such as for non-limiting example diesel oil or mineral oil, or a synthetic base, as the oil or oleaginous phase, and water comprising a salt such as, for non-limiting example, calcium chloride, as the aqueous phase. The drilling fluid further comprises a rheology modifier or additive disclosed herein for rheology stability and particularly for a relatively flat rheological profile over a broad temperature range. Such rheology modifier is a fatty dimer diamine in combination with an acid, or an acid derivative.

The fatty dimer diamine used in one embodiment is a C36 fatty dimer diamine having the following molecular structure:

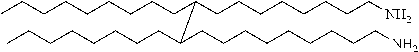 [SMILES: CCCCCCCCCC(CCCCCCCCN)C(CCCCCCCC)CCCCCCCCCN]

One commercially available C36 dimer diamine contains C18 fatty monoamine and C54 fatty trimer triamine which are obtained during the commercial production of the dimer diamine. Generally, quantities of such a fatty dimer diamine ranging from about 1 ppb to about 6 ppb are used in some embodiments and are effective even when the surrounding temperature is as low as 40° F. or above 120° F., or at a temperature in between.

The acid used in the present disclosure in one embodiment is selected from the group of acids generally consisting of boric acid, sulphonic acid, phosphonic acid and various derivatives thereof. Preferred examples of such acids suitable for use in the embodiment include, without limitation, vinyl phosphonic acid, boric acid, adipic acid, and para toluene sulphonic acid. One of ordinary skill in the art will appreciate that acids with similar structures to these might also provide good performance.

While the advantages of the fluids disclosed herein are especially appreciated in drilling deepwater wells, the fluids have broader utility, with potential use in drilling boreholes having a wide range of temperatures and pressures.

In embodiments of the present disclosure providing oleaginous or oil-based, invert emulsion drilling fluids with a relatively flat rheological profile over a broad temperature range, and methods of drilling boreholes in subterranean formations employing such drilling fluids, the term “relatively flat,” as used herein with respect to a rheological profile, is a relative term based on comparison to the rheological profile of known prior art fluids without the rheology additives of the present disclosure. Generally, the drilling fluids of the present disclosure are effective in a temperature range of about 40° F. to at least about 180° F. or higher. The oil base or oleaginous part of the invert emulsion drilling fluid may be a natural oil such as for example diesel oil or mineral oil, or a synthetic base such as, for example, ACCOLADE® base comprising esters or ENCORE® base comprising isomerized olefins, both available from Halliburton Energy Services, Inc., in Houston, Tex. and Duncan, Okla.

An aqueous solution containing a water activity lowering compound, composition or material, comprises the internal phase of the invert emulsion. Such solution is preferably a saline solution comprising for non-limiting example calcium chloride (typically about 25% to about 30%, depending on the subterranean formation water salinity or activity), although other salts or water activity lowering materials such as for non-limiting example alcohols, for example, glycerol, or sugar, known in the art may alternatively or additionally be used. Such other salts may include for non-limiting example sodium chloride, sodium bromide, calcium bromide and formate salts. Water preferably comprises less than 50%, or as much as about 50%, of the drilling fluid and the oil:water ratio preferably ranges from about 50:50 to about 95:5.

Drilling fluids of the present disclosure uniquely include a fatty dimer diamine in combination with an acid additive as a rheology modifier, as will be discussed further below. Further, the drilling fluids of, or for use in, embodiments of the present disclosure, have added to them or mixed with their invert emulsion oil base, other fluids or materials needed to comprise complete drilling fluids. Such other materials optionally may include, for example: additives for enhancing viscosity, for example, an additive having the trade name RHEMOD L™ (modified fatty acid); additives for providing temporary increased viscosity for shipping (transport to the well site) and for use in sweeps, for example, an additive having the trade name TEMPERUS™ (modified fatty acid); additives for filtration control, for example, additives having the trade names ADAPTA® and BDF-366; additives for high temperature high pressure control (HTHP) and emulsion stability, for example, an additive having the trade name FACTANT™ (highly concentrated tall oil derivative); and additives for emulsification, for example, an additive having the trade name EZ MUL® NT (polyaminated fatty acid). All of the aforementioned trademarked products are available from Halliburton Energy Services, Inc. in Houston, Tex., and Duncan, Okla., U.S.A. As with all drilling fluids, the exact formulations of the fluids vary with the particular requirements of the subterranean formation.

The present disclosure advantageously eliminates the need to include additives to provide thinning at cold temperatures, for example, additives having the trade names COLDTROL®, ATC®, and OMC2™. The present disclosure also advantageously eliminates the need to include any additives for rheology control other than the rheological additive of the present disclosure.

A commercially available drilling fluid system for use in some embodiments is the INNOVERT® drilling fluid system, having a paraffin/mineral oil base, available from Baroid, a Halliburton Company, in Houston, Tex. and Duncan, Okla. The INNOVERT® drilling fluid system may typically comprise one or more of the following additives, in addition to the paraffin/mineral oil base and brine, for use as an invert emulsion drilling fluid: RHEMOD™ L modified fatty acid suspension and viscosifying agent, BDF-366™ or ADAPTA™ copolymer for HPHT filtration control, particularly for use at high temperatures, and EZ MUL® NT polyaminated fatty acid emulsifier/oil wetting agent, also particularly for use at high temperatures. Commercially available INNOVERT® drilling fluid systems also typically include TAU-MOD™ amorphous/fibrous material as a viscosifier and suspension agent. However, with the present disclosure, where the drilling fluid system has uniquely added thereto a fatty dimer diamine additive with an acid as a rheology modifier, TAU-MOD™ material is not necessary and is only optionally used if at all.

Embodiments of invert emulsion drilling fluids of the present disclosure comprising fatty dimer diamine with an acid, maintain acceptable and even preferred rheology measurements in deepwater drilling and do not experience a decreased rate of penetration (and with clay-free invert emulsion drilling fluids, also do not experience a decline in flatness of rheology) when in use in drilling even at high pressures and high temperatures (HPHT). HPHT is understood in the industry to refer to the well conditions of a well having an undisturbed bottomhole temperature of 250° F. or greater and a pore pressure of at least 0.8 psi/ft (˜15.3 lbm/gal) or requiring a blowout preventer (BOP) with a rating in excess of 10,000 psi [68.95 MPa]. At HPHT conditions, at changes in pressures and temperatures from high to low and hot to cold and various other combinations, and at high pressure-low temperature conditions, embodiments of the invert emulsion drilling fluids comprising the fatty dimer diamine with acid, have stable rheologies that do not increase sufficiently to fracture the subterranean formation and that provide similar yield point (YP), low shear yield points (LSYP) and gel strength over wide temperature and pressure ranges, such as 40° F. to 180° F. and 0 psi to about 5000 psi. These advantages are believed to be due to the addition of the fatty dimer diamine with the acid to the drilling fluid. The advantages are especially appreciated when the drilling fluid does not also contain organophilic clay or lignite.

Commercially available fatty dimer diamines suitable for use in some embodiments include without limitation VERSAMINE® 552 hydrogenated fatty C36 dimer diamine, and VERSAMINE® 551 fatty C36 dimer diamine, both available from Cognis Corporation (functional products) of Monheim, Germany and Cincinnati, Ohio and PRIAMINE™ 1071, PRIAMINE™ 1073 and PRIAMINE™ 1074 fatty C36 dimer diamine, both available from Croda Internationale Plc of Goole East Yorkshire, United Kingdom and New Castle, Del. Typically, an amount of such dimer diamine in the range of about 1 pound per barrel (ppb) to about 3 ppb is sufficient. These fatty dimer diamines are prepared commercially from fatty dimer diacids which have been produced from dimerisation of vegetable oleic acid or tall oil fatty acid by thermal or acid catalyzed methods.

The dimerisation of C18 tall oil fatty acids produces the material leading to the C36 dimer acids. This material is a mixture of monocyclic dicarboxylic acid, acyclic dicarboxylic acid and bicyclic dicarboxylic acid along with small quantities of trimeric triacids. These diacids are converted into diamines via the reaction scheme given below:

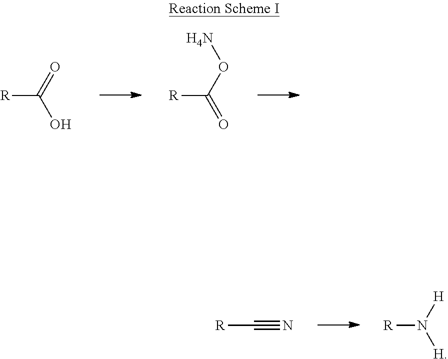

These diamines are further converted into compounds that fall under the scope of fatty dimer diamines. These diamines are converted into cyanoethyl derivatives via cyanoethylation with acrylonitrile; these cyanoethyl derivatives are further reduced into aminopropyl amines via reduction as shown in the reaction scheme II below, as taught in U.S. Pat. No. 4,250,045, issued Feb. 10, 1981 to Coupland, et al.

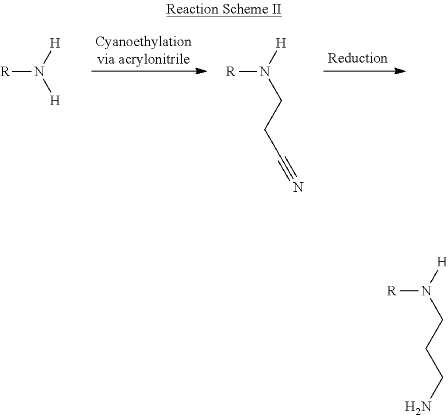

Dicyanoethylated dimer diamine is available commercially as Kemamine DC 3680 and 3695 and di N-aminopropylated dimer diamine is available commercially as Kemamine DD 3680 and 3695 from Chemtura Corporation USA. Different structures of the dimeric fatty dimer diamines are given below:

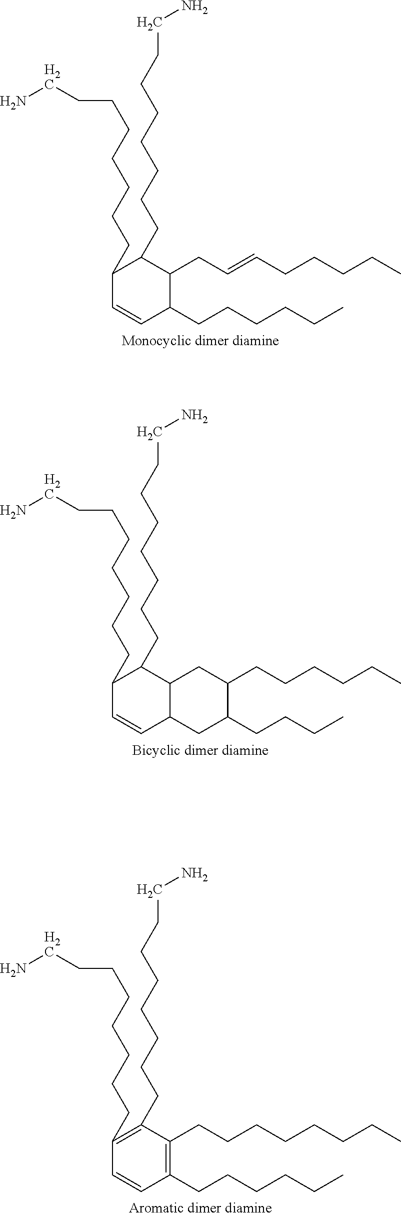 [SMILES: CCCCC/C=C/CC1C(CCCCCC)C=CC(CCCCCCCCN)C1CCCCCCCCN ; CCCCCCC1CC2C(C=CC(CCCCCCCCN)C2CCCCCCCCN)CC1CCCC ; CCCCCCCCc1c(CCCCCC)ccc(CCCCCCCCN)c1CCCCCCCCN]

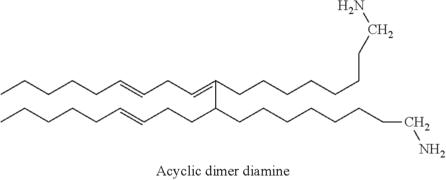 [SMILES: CCCCC/C=C/C/C=C(/CCCCCCCCN)C(CC/C=C/CCCCC)CCCCCCCCN]

Other fatty dimer diamines suitable for use in embodiments of the present disclosure include C28 to C48 fatty dimer amines which are correspondingly prepared via dimerization of the relevant C14 to C24 fatty acids. It should be understood (for example) that C14 means the molecule contains in total 14 carbon atoms.

Acids particularly suited for use in embodiments of the present disclosure are boric acid, sulphonic acid, phosphonic acid, and various derivatives thereof. In one embodiment, preferred examples of such acids include, without limitation, vinyl phosphonic acid, boric acid, adipic acid, and para toluene sulphonic acid. In other embodiments, examples of such acids suitable for use in the invention include, without limitation, lactic acid, formic acid, acrylic acid, acetic acid, chloroacetic acid, dichloroacetic acid, trichloroacetic acid, trifluoroacetic acid, propanoic acid, butyric acid, pentanoic acid, hexanoic acid, heptanoic acid, oxalic acid, malonic acid, succinic acid, glutaric acid, adipic acid, pimelic acid, suberic acid, azelaic acid, sebacic acid, maleic acid, fumaric acid, aspartic acid, citric acid, isocitric acid, aconitic acid, tartaric acid, benzoic acid, p-amino benzoic acid, phthalic acid, terephthalic acid, trimesic acid, sulfuric acid, sulphinic acid, sulphamic acid, sulfonic acid, nitric acid, hydrofluoric acid, hydrochloric acid, phosphinic acid, phosphoric acid, phosphonic acid, organosulfonic acids, organophosphoric acids, boric acid, and boronic acid. Acid derivatives suitable for use in embodiments of the present disclosure, include, without limitation, carboxylic acid esters like lactic acid esters; esters of acetic acid; acetic anhydride; aliphatic polyesters; poly(lactides); poly(glycolides); poly(anhydrides); poly(ortho esters); orthoesters; esters of oxalic acid; poly(amino acids); esters of propionic acid; esters of butyric acid; esters of nitric acid, hydrolyzable organosulfonic acids, and hydrolyzable organophosphoric acids. One of ordinary skill in the art will appreciate that acids and acid derivatives with similar structures to these might also provide good performance. Such acids and acid derivatives will preferably have at least 0.1% w/w (weight of solute/weight of solution) solubility in water at 68° F. As used herein, the term “acid” with respect to an additive of or a component of the fluid of the disclosure, shall be understood to include “acid derivatives” as well as “acids,” as indicated in the examples above, unless specifically indicated to the contrary.

Laboratory tests demonstrate the effectiveness of embodiments of the present disclsoure. The following examples are included to demonstrate some embodiments. It should be appreciated by those of ordinary skill in the art that the techniques and compositions disclosed in the examples which follow represent techniques that function effectively. However, those of ordinary skill in the art should, in light of the present disclosure, appreciate that many changes can be made in the specific embodiments which are disclosed and still obtain a like or similar result without departing from the scope of the claimed subject matter.

General Information Relevant to the Examples follows:

The following abbreviations are sometimes used in describing the results of experimentation: “PV” is plastic viscosity, which is one variable used in the calculation of viscosity characteristics of a drilling fluid, measured in centipoise (cp) units, as further discussed below.
“YP” is yield point, which is another variable used in the calculation of viscosity characteristics of drilling fluids, measured in pounds per 100 square feet (lb/100 ft.²), as further discussed below.
“GELS” is a measure of the suspending characteristics, or the thixotripic properties of a drilling fluid, measured in pounds per 100 square feet (lb/100 ft.²).
“HTHP” is the term used for high-temperature high-pressure fluid loss, measured in milliliters (ml) according to Recommended Practice 13B-2, Recommended Practice for Field Testing of Oil-based Drilling Fluids, Fourth Edition, American Petroleum Institute, Mar. 1, 2005, known to those of ordinary skill in the art.
The necessary components of the claimed drilling fluids include an oil or oleaginous fluid, an aqueous or a non-oleaginous fluid, an emulsifier package, and a rheology modifier. Other chemicals used to make-up the system are basically the same as those typically used in formulating conventional invert emulsion drilling fluids.
All trademarked products in the tables below are available from Halliburton Energy Services, Inc., in Houston, Tex. and Duncan, Okla., except where indicated otherwise.
ADAPTA® crosslinked copolymer is for HTHP filtration control;
BAROID® weighting agent is ground barium sulfate;
EDC 99DW is a base oil for drilling fluids available from TOTAL Petrochemicals USA, Inc. in Houston, Tex.;
EZ MUL® NT emulsifier, which is a polyaminated fatty acid;
REV DUST is an artificial drill solid available from Milwhite Inc, in Houston Tex., that does not comprise any lignite or organophilic clay.
The Plastic Viscosity (PV) and Yield Point (YP) of the invert emulsion drilling fluid were determined on a direct-indicating rheometer, a FANN 35 rheometer, powered by an electric motor. The rheometer consists of two concentric cylinders, the inner cylinder is called a bob, while the outer cylinder is called a rotor sleeve. The drilling fluid sample is placed in a thermostatically controlled cup and the temperature of the fluid is adjusted to 120 (±2)° F. The drilling fluid in the thermostatically controlled cup is then placed in the annular space between the two concentric cylinders of the FANN 35. The outer cylinder or rotor sleeve is driven at a constant rotational velocity. The rotation of the rotor sleeve in the fluid produces a torque on the inner cylinder or bob. A torsion spring restrains the movement of the bob, and a dial attached to the bob indicates displacement of the bob. The dial readings are measured at different rotor sleeve speeds of 3, 6, 100, 200, 300 and 600 revolutions per minute (rpm). Generally, Yield Point (YP) is defined as the value obtained from the Bingham-Plastic rheological model when extrapolated to a shear rate of zero. It may be calculated using 300 rpm and 600 rpm shear rate readings as noted above on a standard oilfield rheometer, such as a FANN 35 or a FANN 75 rheometer.

Similarly, Yield Stress or Tau zero is the stress that must be applied to a material to make it begin to flow (or yield), and may commonly be calculated from rheometer readings measured at rates of 3, 6, 100, 200, 300 and 600 rpm. The extrapolation may be performed by applying a least-squares fit or curve fit to the Herchel-Bulkley rheological model. A more convenient means of estimating the Yield Stress is by calculating the Low-Shear Yield Point (LSYP) by the formula shown below in Equation 2 except with the 6 rpm and 3 rpm readings substituted for the 600-rpm and 300-rpm readings, respectively.

Plastic Viscosity (PV) is obtained from the Bingham-Plastic rheological model and represents the viscosity of a fluid when extrapolated to infinite shear rate. The PV is obtained from the 600 rpm and the 300 rpm readings as given below in Equation 1. A low PV may indicate that a fluid is capable of being used in rapid drilling because, among other things, the fluid has low viscosity upon exiting the drill bit and has an increased flow rate. A high PV may be caused by a viscous base fluid, excess colloidal solids, or both.
The PV and YP are calculated by the following set of equations:

PV=(600 rpm reading)−(300 rpm reading) (Equation 1)

YP=(300 rpm reading)−PV (Equation 2)

More particularly, each of the experiments or tests were conducted in accordance with standard procedures set forth in Recommended Practice 13B-2, Recommended Practice for Field Testing of Oil-based Drilling Fluids, Fourth Edition, American Petroleum Institute, Mar. 1, 2005, known to those of ordinary skill in the art.
A HTHP test measures static filtration behavior of drilling fluid at elevated temperature, up to about 380° F. [193° C.] maximum according to the specifications of API and known to those of ordinary skill in the art. Although the test can simulate downhole temperature conditions, it does not simulate downhole pressure. Total pressure in a cell should not exceed 700 psi [4900 kPa], and the differential pressure across the filter medium is specified as 500 psi [3500 kPa]. Because these cells are half the size of the ambient filtration area, HPHT filtrate volumes after 30 minutes are doubled.

Experiment 1: Four 12 ppg Invert Emulsion Fluids (IEFs) were formulated with a 2 ppb C36 fatty dimer diamine in 12 ppg INNOVERT® clay-free invert emulsion drilling fluid (available from Halliburton Energy Services, Inc., in Duncan, Okla. and Houston, Tex.) in a 70:30 oil-water ratio having a 250K ppm CaCl₂ Water Phase Salinity (WPS) One of these IEFs included no acid and the other three included acids of the present disclsoure, that is, one included 1.75 ppb vinyl phosphonic acid, one included 5 ppb boric acid, and one included 2.75 ppb paratoluene sulphonic acid. All four fluids were hot rolled for 16 hours at 250° F. and the rheologies determined on a FANN 35 rheometer according to API 13B-2 at 120° F. The results are provided in Table 1.

TABLE 1

| | Mixing | Base- | | | |
|---|---|---|---|---|---|
| | time, min | Fluid 1 | Fluid 2 | Fluid 3 | Fluid 4 |
| EDC 99DW, ppb | | 148.90 | 149.50 | 149.50 | 149.50 |
| EZ MUL ® NT, ppb | 2 | 11.00 | 11.00 | 11.00 | 11.00 |
| Lime, ppb | 2 | 1.30 | 1.30 | 1.30 | 1.30 |
| ADAPTA ®, ppb | 5 | 2.00 | 2.00 | 2.00 | 2.00 |
| Vinyl phosphonic acid, | 5 | 0.00 | 1.75 | 0.00 | 0.00 |
| ppb | | | | | |
| Boric acid, ppb | 5 | 0.00 | 0.00 | 5.00 | 0.00 |
| Paratoluene sulphonic | 5 | 0.00 | 0.00 | 0.00 | 2.75 |
| acid, ppb | | | | | |
| CaCl₂, ppb | 5 | 29.30 | 29.30 | 29.30 | 29.30 |
| Water, ppb | | 84.70 | 84.70 | 84.70 | 84.70 |
| Revdust, ppb | 5 | 20.00 | 20.00 | 20.00 | 20.00 |
| BAROID ®, ppb | 10 | 203.20 | 202.88 | 202.88 | 202.88 |
| Fatty Dimer | 5 | 2.00 | 2.00 | 2.00 | 2.00 |
| Diamine, ppb | | | | | |

Hot rolled @ 250° F., 16 hrs, Rheology @ 120° F.

| | | | | | |
|---|---|---|---|---|---|
| 600 rpm | | 54 | 87 | 74 | 91 |
| 300 rpm | | 31 | 60 | 47 | 56 |
| 200 rpm | | 22 | 49 | 37 | 40 |
| 100 rpm | | 14 | 36 | 26 | 26 |
| 6 rpm | | 4 | 17 | 10 | 8 |
| 3 rpm | | 3 | 16 | 10 | 7 |
| PV | | 23 | 27 | 27 | 35 |
| YP | | 8 | 33 | 20 | 21 |
| LSYP | | 2 | 15 | 10 | 6 |
| GELS 10 sec | | 6 | 20 | 14 | 12 |
| GELS 10 min | | 8 | 29 | 25 | 22 |
| HTHP, ml/30 min | — | 2.0 | 2.0 | 1.6 | 2.0 |
| (250° F.) | | | | | |

Table 1 shows that the base formulation of the invert emulsion fluid with the fatty dimer diamine (Fluid Formulation 1) (but no acid additive) had a YP of 8 and an LSYP of 2, whereas the formulations including the acid as well as the fatty dimer diamine each showed significantly better rheology. That is, the formulation with vinyl phosphonic acid (Fluid Formulation 2) had a YP of 38 (312% better than the base formulation) and an LSYP of 15 (650% better than the base formulation); the formulation with boric acid (Fluid Formulation 3) had a YP of 20 (120% better than the base formulation) and an LSYP of 10 (400% better than the base formulation); and the formulation with para toluene sulphonic acid (Fluid Formulation 4) had a YP of 21 (162% better than the base formulation) and an LSYP of 6 (200% better than the base formulation). Thus, this experiment showed that addition of the acid to the fatty dimer diamine rheology modifier enhanced the rheological properties of the invert emulsion fluid.

Experiment 2: Experiment 1 was repeated except the rheology of samples of the different fluid formulations were tested at different temperatures for comparison of stability and dependence on temperature. That is, rheology measurements were taken at 40° F., 80° F., 120° F., and 150° F. to determine whether addition of the acid with the fatty dimer diamine would yield or impart better performance, i.e., less temperature dependence, to the invert emulsion fluid. The results are provided in Tables 2 (base fluid), 3 (with adipic acid), 4 (with vinyl phosphonic acid) and 5 (with boric acid).

TABLE 2

| | Mixing | | | | |
|---|---|---|---|---|---|
| | time, | | | | |
| | min | Base-Fluid 1 | | | |
| EDC 99DW, ppb | | 148.90 | | | |
| EZ MUL ® NT, ppb | 2 | 11.00 | | | |
| Lime, ppb | 2 | 1.30 | | | |
| ADAPTA ®, ppb | 5 | 2.00 | | | |
| CaCl₂, ppb | 5 | 29.30 | | | |
| Water, ppb | | 84.70 | | | |
| Revdust, ppb | 5 | 20.00 | | | |
| BAROID ®, ppb | 10 | 203.20 | | | |
| Fatty Dimer Diamine, | 5 | 2.00 | | | |
| ppb | | | | | |
| Hot rolled | | | | | |
| @ 250° F., 16 hrs, | | 40° F. | 80° F. | 120° F. | 150° F. |
| 600 rpm | | 156 | 81 | 54 | 42 |
| 300 rpm | | 94 | 47 | 31 | 23 |
| 200 rpm | | 72 | 36 | 22 | 15 |
| 100 rpm | | 48 | 24 | 14 | 9 |
| 6 rpm | | 15 | 6 | 4 | 3 |
| 3 rpm | | 12 | 5 | 3 | 2 |
| PV | | 63 | 34 | 23 | 19 |
| YP | | 32 | 13 | 8 | 4 |
| LSYP | | 9 | 4 | 2 | 2 |
| GELS 10 sec | | 12 | 6 | 6 | 5 |
| GELS 10 min | | 14 | 9 | 8 | 8 |

| | |
|---|---|
| HTHP, ml/30 min | 2.0 |
| (250° F.) | |

TABLE 3

| | Mixing | | | | |
|---|---|---|---|---|---|
| | time, | | | | |
| | min | Adipic acid-Fluid 5 | | | |
| EDC 99DW, ppb | | 148.90 | | | |
| EZ MUL ® NT, ppb | 2 | 11.00 | | | |
| Lime, ppb | 2 | 1.30 | | | |
| ADAPTA ®, ppb | 5 | 2.00 | | | |
| Adipic acid, ppb | 5 | 2.50 | | | |
| CaCl₂, ppb | 5 | 29.30 | | | |
| Water, ppb | | 84.70 | | | |
| Revdust, ppb | 5 | 20.00 | | | |
| BAROID ®, ppb | 10 | 202.00 | | | |
| Fatty Dimer Diamine, | 5 | 2.00 | | | |
| ppb | | | | | |
| Hot rolled | | | | | |
| @ 250° F., 16 hrs, | | 40° F. | 80° F. | 120° F. | 150° F. |
| 600 rpm | | 188 | 118 | 97 | 81 |
| 300 rpm | | 107 | 73 | 60 | 52 |
| 200 rpm | | 82 | 57 | 48 | 41 |
| 100 rpm | | 53 | 40 | 34 | 30 |
| 6 rpm | | 15 | 15 | 14 | 17 |
| 3 rpm | | 14 | 13 | 13 | 15 |
| PV | | 81 | 45 | 37 | 29 |
| YP | | 26 | 28 | 23 | 23 |
| LSYP | | 13 | 11 | 12 | 13 |
| GELS 10 sec | | 26 | 17 | 22 | 22 |
| GELS 10 min | | 34 | 39 | 30 | 30 |

| | |
|---|---|
| HTHP, ml/30 min | 2.0 |
| (250° F.) | |

TABLE 4

| | Mixing | | | | |
|---|---|---|---|---|---|
| | time, | | | | |
| | min | Vinyl phosphonic acid-Fluid 2 | | | |
| EDC 99DW, ppb | | 149.50 | | | |
| EZ MUL ® NT, ppb | 2 | 11.00 | | | |
| Lime, ppb | 2 | 1.30 | | | |
| ADAPTA ®, ppb | 5 | 2.00 | | | |
| Vinyl phosphonic acid, | 5 | 1.75 | | | |
| ppb | | | | | |
| CaCl₂, ppb | 5 | 29.30 | | | |
| Water, ppb | | 84.70 | | | |
| Revdust, ppb | 5 | 20.00 | | | |
| BAROID ®, ppb | 10 | 202.88 | | | |
| Fatty Dimer Diamine, | 5 | 2.00 | | | |
| ppb | | | | | |
| Hot rolled | | | | | |
| @ 250° F., 16 hrs, | | 40° F. | 80° F. | 120° F. | 150° F. |
| 600 rpm | | 142 | 109 | 87 | 79 |
| 300 rpm | | 84 | 71 | 60 | 56 |
| 200 rpm | | 66 | 58 | 49 | 47 |
| 100 rpm | | 47 | 43 | 36 | 36 |
| 6 rpm | | 20 | 17 | 17 | 20 |
| 3 rpm | | 18 | 16 | 16 | 18 |
| PV | | 58 | 38 | 27 | 23 |
| YP | | 26 | 33 | 33 | 33 |
| LSYP | | 16 | 15 | 15 | 16 |
| GELS 10 sec | | 22 | 19 | 20 | 20 |
| GELS 10 min | | 38 | 32 | 29 | 27 |

| | |
|---|---|
| HTHP, ml/30 min | 2.0 |
| (250° F.) | |

TABLE 5

| | Mixing | | | | |
|---|---|---|---|---|---|
| | time, | | | | |
| | min | Boric acid-Fluid 3 | | | |
| EDC 99DW, ppb | | 149.50 | | | |
| EZ MUL ® NT, ppb | 2 | 11.00 | | | |
| Lime, ppb | 2 | 1.30 | | | |
| ADAPTA ®, ppb | 5 | 2.00 | | | |
| Boric acid, ppb | | 5.0 | | | |
| CaCl₂, ppb | 5 | 29.30 | | | |
| Water, ppb | | 84.70 | | | |
| Revdust, ppb | 5 | 20.00 | | | |
| BAROID ®, ppb | 10 | 202.88 | | | |
| Fatty Dimer Diamine, | 5 | 2.00 | | | |
| ppb | | | | | |
| Hot rolled | | | | | |
| @ 250° F., 16 hrs, | | 40° F. | 80° F. | 120° F. | 150° F. |
| 600 rpm | | 139 | 94 | 74 | 67 |
| 300 rpm | | 77 | 56 | 47 | 44 |
| 200 rpm | | 53 | 44 | 37 | 35 |
| 100 rpm | | 30 | 32 | 26 | 25 |
| 6 rpm | | 11 | 15 | 10 | 12 |
| 3 rpm | | 11 | 13 | 10 | 12 |
| PV | | 62 | 38 | 27 | 23 |
| YP | | 15 | 18 | 20 | 21 |
| LSYP | | 11 | 11 | 10 | 12 |
| GELS 10 sec | | 17 | 17 | 14 | 14 |
| GELS 10 min | | 24 | 25 | 25 | 24 |

| | |
|---|---|
| HTHP, ml/30 min | 1.6 |
| (250° F.) | |

The results of Experiment 2 show that the rheological properties of the base formulation (Fluid Formulation 1) for the invert emulsion fluid, without the acid with the fatty dimer diamine for the rheology modifier, were temperature dependent. The rheological properties decreased with the increase in temperature. The YP for Fluid Formulation 1, the base fluid, was 32 at 40° F. and gradually decreased to 4 at 150° F. The Gel at 10 minutes was 14 and gradually decreased to 8 at 150° F. The 10 minute Gel provides a measure of fluid suspension.

Table 3 presents the formulation and results for the base fluid with a fatty dimer diamine and adipic acid rheology modifier of the present disclosure. The YP for this formulation was in the range of 23 to 28 from 40° F. to 150° F., the LSYP was in the range of 11 to 13 from 40° F. to 150° F. and the 10 minute Gel was in the range of 30 to 39 from 40° F. to 150° F. These results indicate a relatively or substantially flat rheology, relatively or substantially independent of temperature, according to the present disclosure.

Table 4 presents the formulation and results for the base fluid with a fatty dimer diamine and vinyl phosphonic acid rheology modifier of the present disclosure. The YP for this formulation was in the range of 26 to 33 from 40° F. to 150° F., the LSYP was in the range of 15 to 16 from 40° F. to 150° F. and the 10 minute Gel was in the range of 27 to 38 from 40° F. to 150° F. These results also indicate this invert emulsion fluid formulated according to the present disclosure has a relatively or substantially flat rheology relatively or substantially independent of temperature.

Table 5 presents the formulation and results for the base fluid with a fatty dimer diamine and boric acid rheology modifier of the present disclosure. The YP for this formulation was in the range of 15 to 21 from 40° F. to 150° F., the LSYP was in the range of 10 to 12 from 40° F. to 150° F. and the 10 minute Gel was in the range of 24 to 25 from 40° F. to 150° F. Again, these results indicate flat rheology and a fluid relatively independent of temperature, according to the present disclosure.

In these experiments above, the yield point (YP) and the low shear yield point (LSYP) of the invert emulsion base fluid, which is a typical invert emulsion base fluid for drilling, without the rheology additive disclosed herein, when measured at 150° F., varied more than 500% and 250% respectively when compared to the YP and LSYP measured at 40° F. In contrast, the YP of that drilling fluids with the rheology additive disclosed herein, Fluids 2, 3, and 5 above, measured at 150° F., did not vary by more than 30% over a temperature range of about 40° F. to about 180° F., and the LSYP of the drilling fluid with the rheology additive disclosed herein, measured at 150° F., did not vary by more than 20% over a temperature range of about 40° F. to about 180° F.

The rheology modifier of the present disclosure, when used with invert emulsion fluids, enables the fluids to be used at low temperatures, such as encountered in deepwater drilling, without need for a thinner. The rheology modifier of the present disclosure thus simplifies the formulation for the invert emulsion drilling fluid and consequently saves costs. The flat rheology afforded by the rheology modifier of the present disclosure also results in a better performing invert emulsion drilling fluid. With flat rheology or substantially flat rheology, the fluid will have substantially controlled ECD (equivalent circulating density) along the drill string, notwithstanding a change in the temperature surrounding the string. A controlled ECD avoids lost circulation of the fluid and significantly reduces the risk of formation fractures during drilling.

The advantages of the method of the present disclosure may be obtained by employing a drilling fluid of the present disclosure in drilling operations. The drilling operations—whether drilling a vertical or directional or horizontal borehole, conducting a sweep, or running casing and cementing—may be conducted as known to those of ordinary skill in the art with other drilling fluids. That is, a drilling fluid is prepared or obtained and circulated through a wellbore as the wellbore is being drilled (or swept or cemented and cased) to facilitate the drilling operation. The drilling fluid removes drill cuttings from the wellbore, cools and lubricates the drill bit, aids in support of the drill pipe and drill bit, and provides a hydrostatic head to maintain the integrity of the wellbore walls and prevent well blowouts. The specific formulation of the drilling fluid is optimized for the particular drilling operation and for the particular subterranean formation characteristics and conditions (such as temperatures). For example, the fluid is weighted as appropriate for the formation pressures and thinned as appropriate for the formation temperatures. The fluids of the present disclosure afford real-time monitoring and rapid adjustment of the fluid to accommodate changes in such subterranean formation conditions. Further, the fluids of the present disclosure may be recycled during a drilling operation such that fluids circulated in a wellbore may be recirculated in the wellbore after returning to the surface for removal of drill cuttings for example. The drilling fluid may even be selected for use in a drilling operation to reduce loss of drilling mud during the drilling operation and/or to comply with environmental regulations governing drilling operations in a particular subterranean formation.

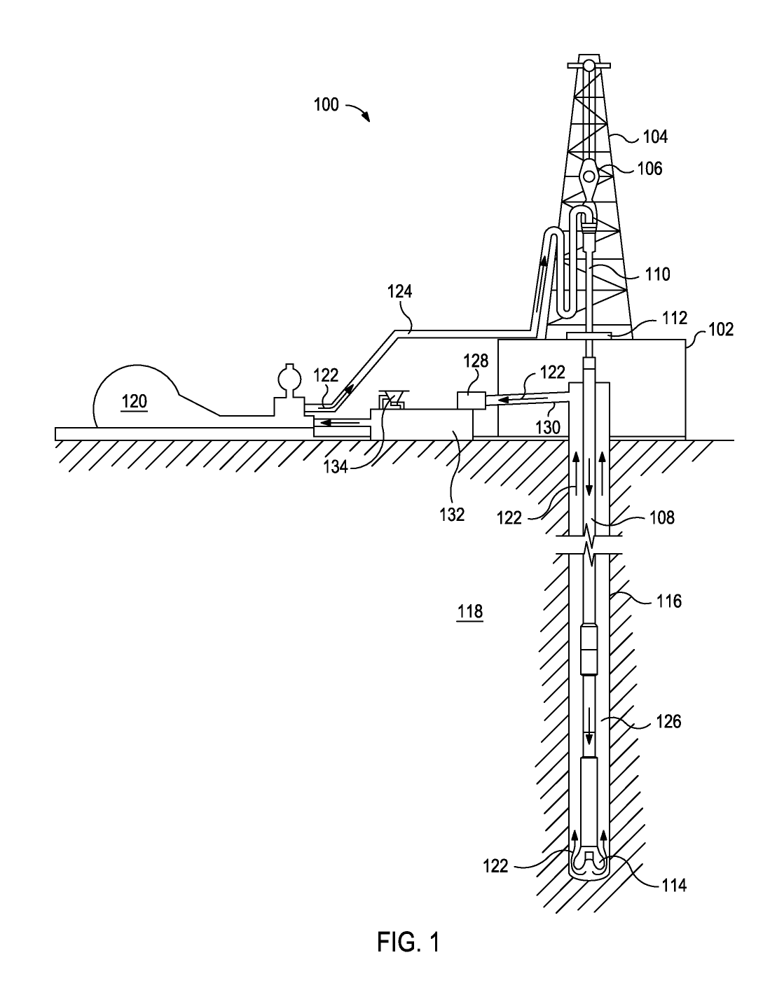

The exemplary rheology additives disclosed herein may directly or indirectly affect one or more components or pieces of equipment associated with the preparation, delivery, recapture, recycling, reuse, and/or disposal of the disclosed additives. For example, and with reference to FIG. 1, the disclosed additives may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed additives may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed additives may be stored, reconditioned, and/or regulated until added to the drilling fluid 122.

As mentioned above, the disclosed additives may directly or indirectly affect the components and equipment of the drilling assembly 100. For example, the disclosed additives may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, The fluid processing unit(s) 128 may further include one or more sensors, gauges, pumps, compressors, and the like used store, monitor, regulate, and/or recondition the exemplary additives.

The disclosed additives may directly or indirectly affect the pump 120, which representatively includes any conduits, pipelines, trucks, tubulars, and/or pipes used to fluidically convey the additives downhole, any pumps, compressors, or motors (e.g., topside or downhole) used to drive the additives into motion, any valves or related joints used to regulate the pressure or flow rate of the additives, and any sensors (i.e., pressure, temperature, flow rate, etc.), gauges, and/or combinations thereof, and the like. The disclosed additives may also directly or indirectly affect the mixing hopper 134 and the retention pit 132 and their assorted variations.

The disclosed additives may also directly or indirectly affect the various downhole equipment and tools that may come into contact with the additives such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed additives may also directly or indirectly affect any downhole heat exchangers, valves and corresponding actuation devices, tool seals, packers and other wellbore isolation devices or components, and the like associated with the wellbore 116. The disclosed additives may also directly or indirectly affect the drill bit 114, which may include, but is not limited to, roller cone bits, PDC bits, natural diamond bits, any hole openers, reamers, coring bits, etc.

While not specifically illustrated herein, the disclosed additives may also directly or indirectly affect any transport or delivery equipment used to convey the additives to the drilling assembly 100 such as, for example, any transport vessels, conduits, pipelines, trucks, tubulars, and/or pipes used to fluidically move the additives from one location to another, any pumps, compressors, or motors used to drive the additives into motion, any valves or related joints used to regulate the pressure or flow rate of the additives, and any sensors (i.e., pressure and temperature), gauges, and/or combinations thereof, and the like.

The foregoing description is intended to be a description of some embodiments. Various changes in the details of the described drilling fluids and additives and methods of use can be made without departing from the intended scope of this disclosure as defined by the appended claims.

What is claimed is:

1. A method for drilling in a subterranean formation comprising providing or using in the drilling an invert emulsion drilling fluid having an oleaginous continuous phase, a non-oleaginous discontinuous phase, and a rheology modifier comprising a fatty dimer diamine having 28 to 48 carbon atoms per molecule and an acid or an acid derivative.

2. The method of claim 1 wherein the drilling fluid is formulated without the addition of organophilic clays or lignites and organophilic clays and lignites are not added to the drilling fluid during drilling.

3. The method of claim 1 wherein the yield point and the low shear yield point of the drilling fluid is substantially the same at temperatures ranging from about 40° F. to about 180° F.

4. The method of claim 3 wherein the yield point and the low shear yield point of the drilling fluid is about the same at pressures ranging from about 0 to about 5000 psi.

5. The method of claim 1 wherein the 10 min gel strength of the drilling fluid is substantially the same at temperatures ranging from about 40° F. to about 180° F.

6. The method of claim 5 wherein the 10 min gel strength of the drilling fluid is about the same at pressures ranging from about 0 to about 5000 psi.

7. The method of claim 1 wherein the fatty dimer diamine has 36 carbon atoms per molecule.

8. The method of claim 1 wherein the yield point of the drilling fluid measured at 150° F. does not vary by more than 30% over a temperature range of about 40° F. to about 180° F., and the low shear yield point of the drilling fluid measured at 150° F. does not vary by more than 20% over a temperature range of about 40° F. to about 180° F.

9. The method of claim 1 wherein the acid has at least 0.1% w/w solubility in water at 68° F.

10. The method of claim 1 wherein the acid is selected from the group of acids consisting of: lactic acid; formic acid; acrylic acid; acetic acid; chloroacetic acid; dichloroacetic acid; trichloroacetic acid; trifluoroacetic acid; propanoic acid; butyric acid; pentanoic acid; hexanoic acid; heptanoic acid; oxalic acid; malonic acid; succinic acid; glutaric acid; adipic acid; pimelic acid; suberic acid; azelaic acid; sebacic acid; maleic acid; fumaric acid; aspartic acid; citric acid; isocitric acid; aconitic acid; tartaric acid; benzoic acid; p-amino benzoic acid; phthalic acid; terephthalic acid; trimesic acid; sulfuric acid; sulphinic acid; sulphamic acid; sulfonic acid; nitric acid; hydrofluoric acid; hydrochloric acid; phosphinic acid; phosphoric acid; phosphonic acid; organosulfonic acids; organophosphoric acids; boric acid; boronic acid; carboxylic acid; para toluene sulphonic acid; vinyl phosphonic acid; and mixtures of said acids.

11. The method of claim 1 wherein the acid derivative is selected from the group of acid derivatives consisting of: lactic acid esters and other carboxylic acid esters; esters of acetic acid; acetic anhydride; aliphatic polyesters; poly(lactides); poly(glycolides); poly(anhydrides); poly(ortho esters); orthoesters; esters of oxalic acid; poly(amino acids); esters of propionic acid; esters of butyric acid; esters of nitric acid, hydrolyzable organosulfonic acids, hydrolyzable organophosphoric acids; and mixtures of said acid derivatives.

12. The method of claim 1 wherein the oleaginous phase comprises an oil selected from the group consisting of: a synthetic oil comprising an ester or olefin; a diesel oil; a mineral oil selected from the group consisting of n-paraffins, iso-paraffins, cyclic alkanes, branched alkanes; and mixtures thereof.

13. The method of claim 1 wherein the non-oleaginous discontinuous phase is an aqueous solution containing a water activity lowering material selected from the group consisting of: alcohols; sugar; salts selected from the group consisting of calcium chloride, calcium bromide, sodium chloride, sodium bromide, and formate; and combinations thereof.

14. The method of claim 1 wherein the drilling fluid has a mud weight in the range of about 9 to about 18 ppg.

15. The method of claim 1 wherein the drilling fluid comprises from about 0.25 ppb to about 18 ppb of fatty dimer diamine.

16. The method of claim 1 wherein the drilling fluid comprises from about 0.25 ppb to about 10 ppb of acid or acid derivative.

17. The method of claim 1 wherein the drilling fluid has an oil:water ratio in the range of about 50:50 to about 95:5.

18. The method of claim 1 wherein the drilling fluid with the rheology modifier, when compared to the drilling fluid without the rheology modifier, has a characteristic selected from the group consisting of: an increased yield point; an increased low shear yield point; an increased gel strength; and any combination thereof.

19. An invert emulsion drilling fluid comprising a continuous oleaginous phase and a discontinuous non-oleaginous phase in an oil:water ratio in the range of about 50:50 to about 95:5, a rheology modifier comprising a C36 fatty dimer diamine having the following molecular structure: 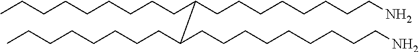 [SMILES: CCCCCCCCCC(CCCCCCCCN)C(CCCCCCCC)CCCCCCCCCN]
and an acid, wherein the drilling fluid is formulated without the addition of organophilic clays or lignites, and such that the yield point and gel strength of the drilling fluid is substantially the same at temperatures ranging from about 40° F. to about 180° F.

20. The invert emulsion drilling fluid of claim 19 wherein the acid is selected from the group consisting of adipic acid, boric acid, sulphonic acid, para toluene sulphonic acid, phosphonic acid, vinyl phosphonic acid, and derivatives and mixtures thereof.

21. A drilling fluid system comprising a drilling fluid and assembly wherein the drilling fluid affects one or more components or equipment comprising the assembly and the drilling fluid comprises an invert emulsion having an oleaginous continuous phase, a non-oleaginous discontinuous phase, and a rheology modifier comprising a fatty dimer diamine having 28 to 48 carbon atoms per molecule and an acid or an acid derivative.
